(19) United States
(12) Patent Application Publication
(10) Pub. No.: US 2002/0167682 A1
(43) Pub. Date: Nov. 14, 2002

(54) Universal image capture language

(76) Inventors: Mimi Chu Dong, Greeley, CO (US); John L. Reed, Greeley, CO (US); Robert D. Thompson, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/852,836

(22) Filed: May 10, 2001

(51) Int. Cl. B41B 1/00; G06F 15/00

(52) U.S. Cl. 358/1.13

(57) ABSTRACT

The present disclosure relates to a universal image capture language that can be used in communicating image data, and a method for communicating image data to an electrical device. The method can be summarized by the steps of transceiving a device identification to the electrical device in a universal image capture language and transmitting image data to the electrical device. In addition, the present disclosure relates to a method for receiving image data from an image capture device comprising the steps of receiving a device identification from the image capture device communicated in a universal image capture language, interpreting the device identification, and receiving the image data from the image capture device.

### FIELD OF THE INVENTION

The present disclosure relates to a universal image capture language used in association with image data. More particularly, the present disclosure relates to devices that communicate in the universal image capture language and methods for using these devices.

### BACKGROUND OF THE INVENTION

Many electrical devices process data through internal communications “spoken” in various languages. Through such internal communications, commands can be transmitted from various internal components to others within the device. By way of example, inside a personal computer (PC), a processor can issue commands to a storage device, such as a hard drive, by speaking to the hard drive in a particular language in which the hard drive is fluent.

Various languages have been developed for various applications. For instance, many printers speak a printer command language (PCL), while many scanners speak a scanner command language (SCL). In that the language spoken by a PC is normally different from that spoken by a peripheral device such as a printer or scanner, the PC must include some means for translating communications from the peripheral device so that the PC and peripheral device can communicate with each other. Typically, these means include a peripheral driver that comprises software that is downloaded to the PC prior to use of the peripheral device.

In the past, the arrangement described above has been viable and has created little difficulty as long as the proper driver was available. More recently, however, difficulties have arisen due to the distinct languages spoken by electronic devices. This is particularly true in the case of image capture. Presently, many different image capture devices are being introduced in the market that speak different languages. This is generally not a problem where the image capture device is intended for use with just one or two specific computing devices, such as a PC; however, many image capture devices are intended for more universal usage. For instance, digital cameras (both still and video) are being developed that can download images directly to PCs for viewing and to printers for the creation of hard copies of the images captured by the camera. Where the selected PC or printer does not speak the camera's language, such use cannot be accommodated.

The language problem affects other areas of image capture. For example, many hybrid devices sold in the market are capable of various functionalities. One such device is the multifunction peripheral (MFP) device that is, for instance, capable of operating as a printer, scanner, facsimile machine, and digital sender (e.g., via email). Due to its multifunctionality, such MFP devices typically comprise several different components that are independently responsible for one or more of the various functionalities. For instance, printing is performed by a print engine, scanning is performed by an internal scanner, etc. Typically, these components speak to each other during use of the device when the various functions are performed. Where all of the components speak the same language, all such functionalities can be performed without problem. Difficulty arises, however, for the device vendor that wishes to incorporate a component (e.g., scanner) into the device that speaks a language different from the other components of the device. Although the component to be added can be reconfigured to speak the other language by reprogramming it or providing an intermediary translation component, the time and resources necessary to reprogram the component or develop an effective translation component can be prohibitive.

### SUMMARY OF THE INVENTION

From the foregoing, it can be appreciated that it would be desirable to have a universal language for image capture devices, and devices which interact with image capture devices, that avoids one or more of the drawbacks discussed above.

The present disclosure relates to a universal image capture language that can be used in communicating image data, and a method for communicating image data to an electrical device comprising the steps of transceiving a device identification to the electrical device in a universal image capture language and transmitting image data to the electrical device.

In another embodiment, the present disclosure relates to a method for receiving image data from an image capture device comprising the steps of receiving a device identification from the image capture device communicated in a universal image capture language, interpreting the device identification, and receiving the image data from the image capture device.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic view showing various devices associated with image capture.

FIG. 2 is a schematic view of an image capture device shown in FIG. 1.

FIG. 3 is a schematic view of a computing device shown in FIG. 1.

FIG. 4 is a schematic view of a peripheral device shown in FIG. 1.

FIG. 5 is a flow diagram that illustrates operation of a communication module shown in FIG. 2.

FIG. 6 is a flow diagram that illustrates operation of communication modules shown in FIGS. 3 and 4.

### DETAILED DESCRIPTION

As identified above, various problems arise where more than one language is used in the image capture area. Accordingly, it has been determined to provide a universal language for substantially all devices used to capture images, as well as those devices that communicate with the image capture devices. Where a universal language is used, the user has the freedom to utilize many different devices for displaying or otherwise outputting captured images, even where the other devices are not provided with a driver specifically intended for the image capture device. In addition, device vendors can more easily integrate available image capture components (e.g., scanners) into the multifunction devices they produce. Examples are provided below which identify advantageous results that can be achieved through implementation of the universal language.

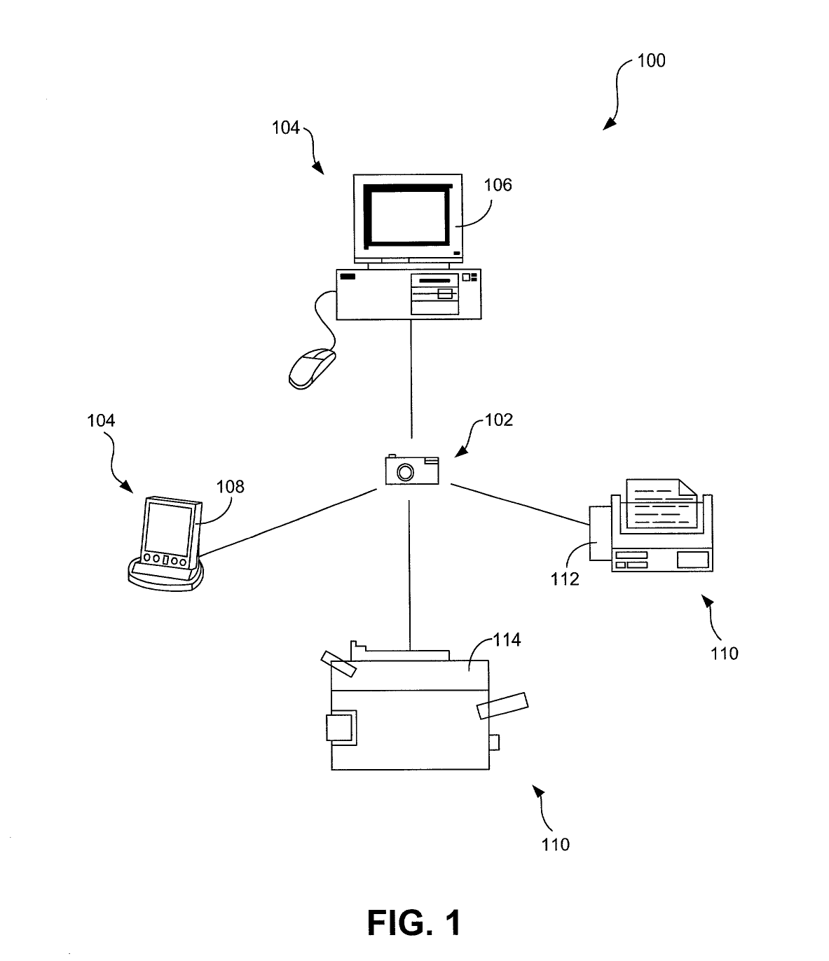

Referring now in more detail to the drawings, in which like numerals indicate corresponding parts throughout the several views, FIG. 1 illustrates a collection 100 of various electrical devices that are associated with image capture or with the manipulation of the data obtained through image capture. As indicated in FIG. 1, provided is an image capture device 102. As illustrated in the figure, the image capture device 102 can comprise a digital still or video camera. As used herein, the term “digital camera” is used to designate still cameras, video cameras, or both. Alternatively, the image capture device 102 can comprise a scanner. Irrespective of its particular configuration, the image capture device 102 is capable of creating digital images and storing them for later viewing and/or manipulation. Further illustrated in FIG. 1 are computing devices 104 that are electrically connected to the image capture device 102. By way of example, the computing devices 104 comprise a personal computer (PC) 106 and a personal digital assistant (PDA) 108. Although actual, physical electrical connection between the computing devices 104 and the image capture device 102 is depicted in FIG. 1, it will be understood that these electrical connections could, alternatively, be wirelessly connected.

In addition to the image capture device 102 and the computing devices 104, shown in FIG. 1 are peripheral devices 110. As indicated in FIG. 1, these devices 110 can include a facsimile machine 112 that is able to scan and transmit printed media and a printer 114 that is capable of receiving print data and producing printed hard-copies. Like the computing devices 104, each of the peripheral devices 110 is electrically connected to the image capture device 102. Again, this electrical connection can be facilitated through wireless communications. It is to be appreciated that although particular image capture, computing, and peripheral devices are shown and described herein, these devices are provided as examples only to facilitate discussion of the benefits that can be achieved through implementation of the universal language.

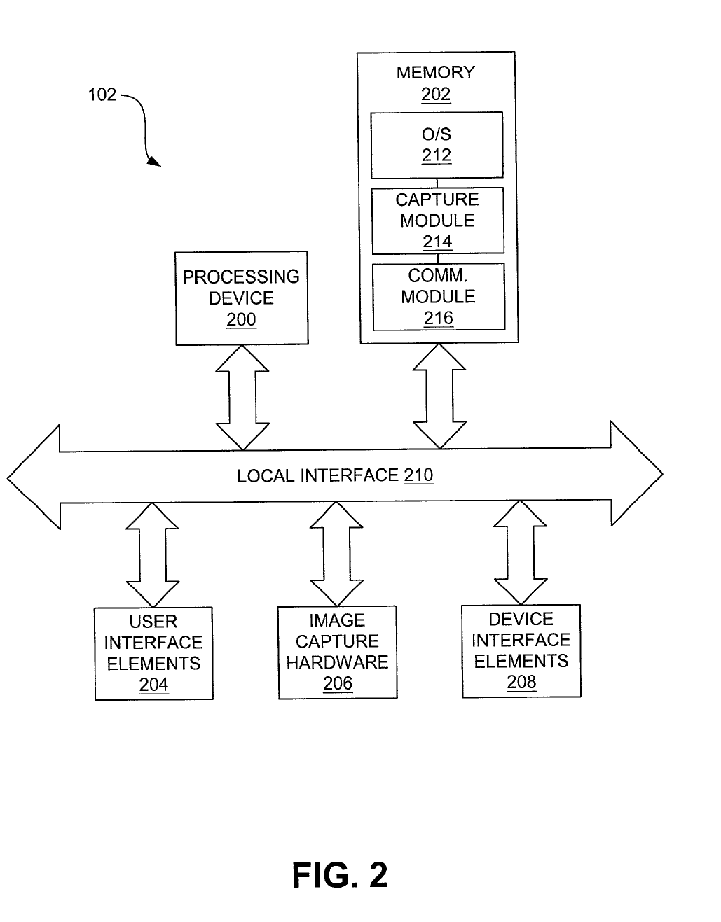

FIG. 2 is a schematic view illustrating an example architecture for the image capture device 102 shown in FIG. 1. As indicated in FIG. 2, the image capture device 102 comprises a processing device 200, memory 202, user interface elements 204, image capture hardware 206, device interface elements 208, and a local interface 210 to which each of the other components electrically connects. The processing device 200 is adapted to execute commands stored in memory 202 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the image capture device 102. The user interface elements 204 typically comprise interface tools with which the device settings can be changed and through which the user can communicate commands to the image capture device 102. By way of example, the interface elements 204 can comprise one or more function buttons with which the operation of the image capture device 102 can be controlled and an image capture button with which the device can be commanded to capture images.

The image capture hardware 206 comprises the various components that are used to physically capture images. Where the image capture device 102 is a camera (still and/or video), this hardware 206 can, for example, include a lens, one or more focusing elements (lenses, mirrors, etc.), one or more light sensing elements (e.g., charge-coupled device (CCD)), viewfinder, and so forth. Where the image capture device 102 is a scanner, this hardware can include a platen, optical sensor, focusing mechanism, etc. The device interface elements 208 are adapted to facilitate the transfer of image data from the image capture device 102 to other devices such as a computing device 104 and a peripheral device 106. By way of example, these interface elements can comprise a data transmitting/receiving device and one or more communication ports. As indicated above, communications can either be facilitated through direct electrical connection or wirelessly.

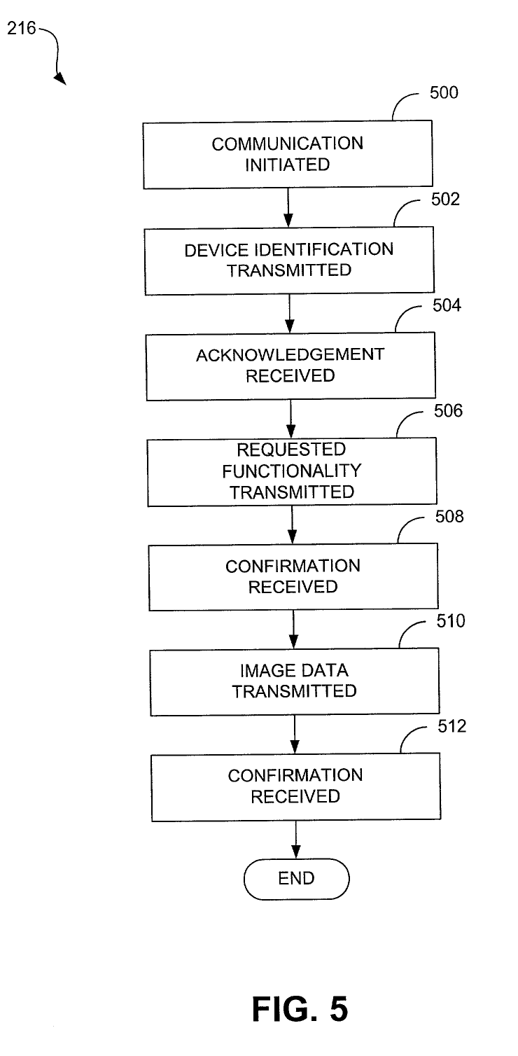

The memory 202 includes an operating system 212, an image capture module 214, and a communication module 216. The operating system 212 contains the various commands used to control the general operation of the image capture device 102, while the image capture module 214 comprises software and/or firmware that is adapted to, in conjunction with the image capture hardware 206, facilitate the capture (i.e., retrieval and storage) of images. Accordingly, the operating system 212 preferably controls the general operation of the device 102, while the image capture module is specifically configured to control image capture operations. The communication module 216 comprises software and/or firmware that is adapted to, in conjunction with the device interface elements 208, communicate with other devices, such as a computing device 104 and a peripheral device 110, such that the image data that has been captured by the image capture device 102 can be displayed, output, or otherwise manipulated by these other devices. The operation of the communication module 216 is discussed in detail below in relation to FIG. 5.

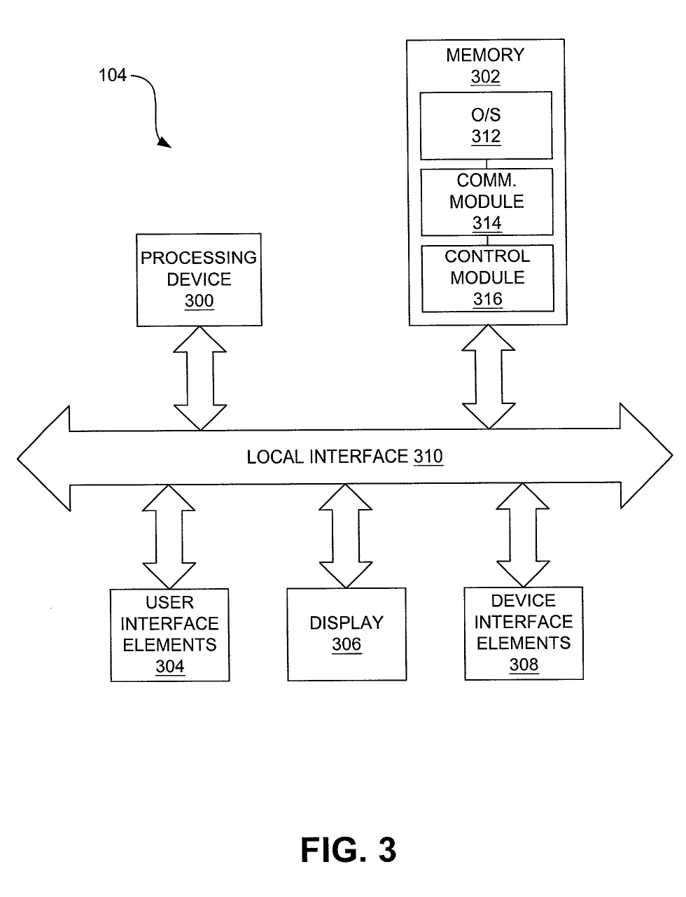

FIG. 3 is a schematic view illustrating an example architecture for the computing devices 104 shown in FIG. 1. As indicated in FIG. 3, each computing device 104 comprises a processing device 300, memory 302, user interface devices 304, a display 306, and device interface elements 308. Each of these components is connected to a local interface 310 that, by way of example, comprises one or more internal buses. The local interface 310 may have additional elements, which are omitted for simplicity, such as controllers, buffers (caches), drivers, repeaters, and receivers, to enable communications. Furthermore, the local interface 310 may include address, control, and/or data connections to enable appropriate communications among the aforementioned components.

The processing device 300 comprises hardware for executing software and/or firmware that is stored in memory 302. The processing device 300 can include any custom made or commercially available processor, a central processing unit (CPU) or an auxiliary processor among several processors associated with the computing device 104, and a semiconductor based microprocessor (in the form of a microchip) or a macroprocessor. The memory 302 can include any one of combination of volatile memory elements (e.g., random access memory (RAM, such as DRAM, SRAM, etc.)) and nonvolatile memory elements (e.g., ROM, hard drive, tape, CDROM, etc.). Moreover, the memory 302 can incorporate electronic, magnetic, optical, and/or other types of storage media. Note that the memory 302 can have a distributed architecture, where various components are situated remote from one another, but accessible by the processing device 300.

The user interface elements 304 typically comprise those normally used in conjunction with computing devices. For instance, where the computing device 104 comprises a PC, the user interface elements 304 can include a keyboard, mouse, etc. Where the computing device 104 comprises a PDA, the user interface elements 306 can comprise a touch-sensitive display screen that can be utilized with a stylus, as well as one or more function buttons. The display 306 typically comprises a monitor for a PC and the display screen noted above for a PDA. The device interface elements 308 comprise the hardware with which the computing device 104 transmits and receives information to and from another device such as the image capture device 102. By way of example, the device interface elements 308 can, like the image capture device 102, include a data transmitting/receiving device and one or more communication ports. As indicated above, communications can either be facilitated through direct electrical connection or wirelessly.

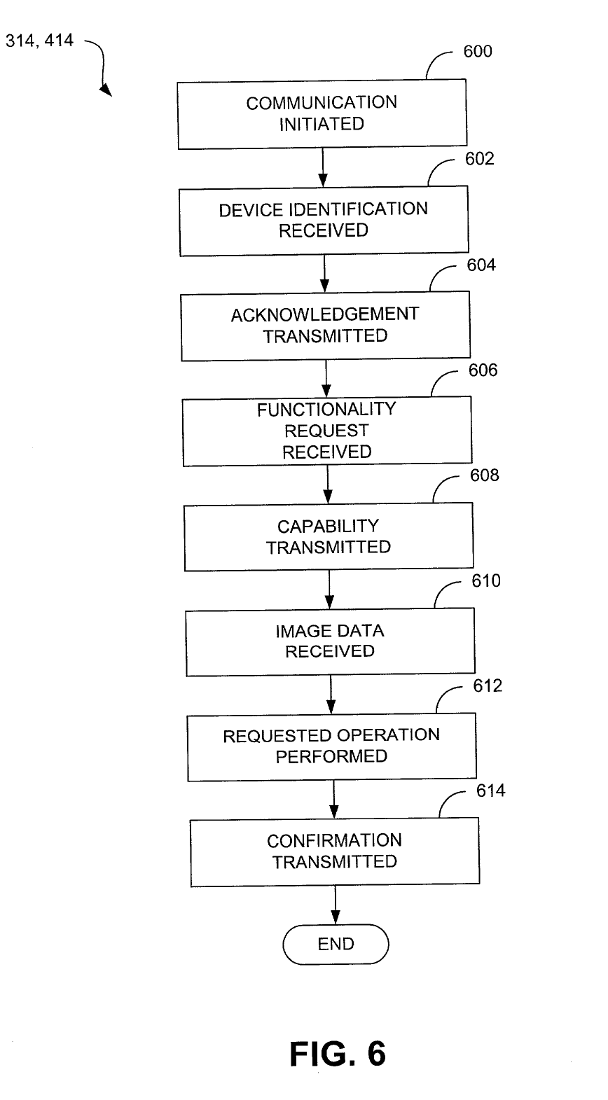

As indicated in FIG. 3, the memory 302 comprises various software and/or firmware. In particular, the memory 302 includes an operating system 312, a communication module 314, and a control module 316. The operating system 312 controls the execution of other software and/or firmware, such as the communication module 314 and control module 316, and provides scheduling, input-output control, file and data management, memory management, and communication control and related services. The communication module 314 preferably comprises software and/or firmware that is adapted to, in conjunction with the device interface elements 308, communicate with another device, such as the image capture device 102, such that the computing device can receive the image data captured by the image capture device. By way of example, this module 314 comprises a universal image capture driver that, as discussed below, is fluent in a universal image capture language used to communicate with image capture devices. In a preferred arrangement, the universal image capture driver is configured such that it can be used to communicate with substantially any image capture device. This configuration is possible due to commonality of the processing associated with image and image capture in general including sharpening, data compression, etc. The operation of the communication module 314 is discussed in greater detail below with reference to FIG. 6. Once image data is received, it can be manipulated in some manner (e.g., displayed, modified, transmitted, etc.) with the control module 316. As will be appreciated by persons having skill in the art, the control module 316 can comprise various individual software and/or firmware applications designed for manipulating image data.

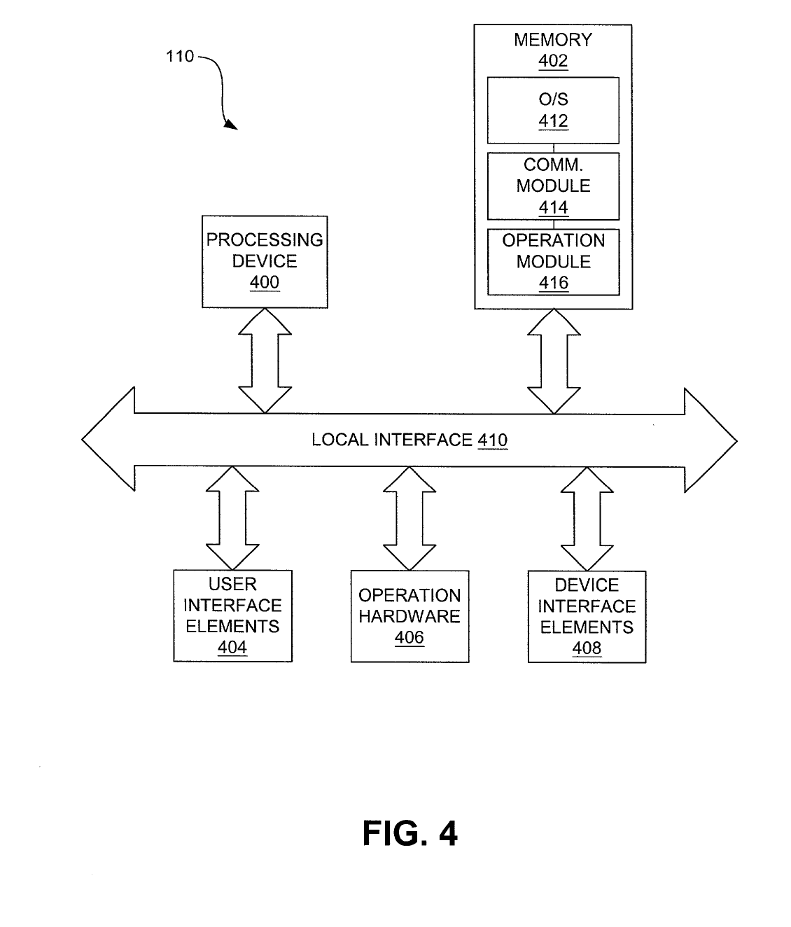

FIG. 4 is a schematic view illustrating an example architecture for one of the peripheral devices 110 shown in FIG. 1. As indicated in FIG. 4, each peripheral device 110 typically comprises a processing device 400, memory 402, user interface elements 404, device operation hardware 406, device interface elements 408, and a local interface 410 to which each of the other components electrically connects. The processing device 400 is adapted to execute commands stored in memory 402 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the peripheral device 110. The user interface elements 404 typically comprise interface tools with which the device settings can be changed and through which the user can communicate commands to the peripheral device 110. By way of example, the interface elements 404 can comprise one or more function keys with which the operation of the peripheral device 110 can be controlled.

The nature of the device operation hardware 406 depends upon the configuration of the device and the functionality which it is designed to perform. Generally speaking, however, the device operation hardware 406 comprises the various components that are used to operate the device 110 to perform a designated functionality. Therefore, this hardware can comprise an electrophotographic imaging device a print engine, and so forth. The device interface elements 408, like elements 308 of the computing device 104, comprise the hardware with which information is transmitted to and received from another device such as the image capture device 102. By way of example, the device interface elements 308 can include a data transmitting/receiving device and one or more communication ports. Again, communications can either be facilitated through direct electrical connection or wirelessly.

The memory 402 includes an operating system 412, a communications module 414, and a device operation module 416. The operating system 412 controls the execution of other software and/or firmware, such as the communication module 414 and device operation module 416, and provides scheduling, input-output control, file and data management, memory management, and communication control and related services. The communication module 414 comprises software and/or firmware that is adapted to, in conjunction with the device interface elements 408, communicate with another device such as the image capture device 102, so that the peripheral device 110 can receive the image data captured by the image capture device. Like the module 314, the module 414 can comprise a universal image capture driver that is fluent in a universal image capture language such that the device 110 can communicate with multiple image capture devices. The operation of the communication module 414 is discussed below with reference to FIG. 6. Once image data is received, it can be manipulated in some manner (e.g., printed, transmitted, etc.) with the device operation module 416. As with the device operation hardware 406, the nature of the device operation module 416 depends upon the configuration of the device 110 and the functionality it is designed to perform. The operation module 416 is specifically adapted to control such operations.

Various software and/or firmware modules have been described herein. It is to be understood that these modules can be stored on any computer readable medium for use by or in connection with any computer related system or method. In the context of this document, a computer readable medium is an electronic, magnetic, optical, or other physical device or means that can contain or store a computer program for use by or in connection with a computer related system or method. These modules can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium could even be paper or another suitable medium upon which a program is printed, as the program can be electronically captured, via for instance optical scanning of the paper or other medium, then compiled, interpreted or otherwise processed in a suitable manner if necessary, and then stored in a computer memory.

FIG. 5 illustrates operation of the communication module 216 of the image capture device 102. As indicated in this figure, a communication is first initiated, as identified in block 500. This communication can be initiated by the image capture device 102 through a command input into the device by the device user via the user interface elements 204. Alternatively, this communication can be initiated by another device that is connected to the image capture device 102, for example by a computing device 104 or a peripheral device 110. In either case, the communication is made in a universal language spoken by both devices, identified herein as the universal image capture language (ICL). The communication can comprise a plurality of escape sequences that initiate communication between the devices. As identified below, the universality of the ICL facilitates communication even where a specific driver for the image capture device 102 is not stored on the other device (e.g., computing device 104 or peripheral device 110). Once the initial communication is made, the communication module 216 of the image capture device 102 transmits (i.e., transceives) a device identification communication that identifies the nature of the image capture device, as indicated in block 502. Again, this communication can comprise a series of escape sequences that begin with a class identification. The class identification can, for instance, be in the form of: <esc><“ClassID”><“Camera”> for a camera or <esc><“ClassID”><“Scanner”> for a scanner. By transmitting this information, the receiving device can know what type of device it is communicating with and, therefore, what functionality will be required.

After the device identification is transmitted, an acknowledgement transmission is received from the other device, as indicated in block 504. This communication both confirms the other device's fluency in ICL and can further include an indication as to its compatibility with the image capture device 102. At this point, the communication module 216 can transmit the requested functionality to the other device, as identified in block 506. This communication therefore normally comprises instructions as to what the other device is being called upon to do by the image capture device 102. For instance, where the other device is a computing device 104, these instructions may command the computing device to display one or more images and/or store them. Where the other device is a peripheral device 110, the instructions may command the peripheral device to create hard copies of one or more images (in the case of a printer) or electronically transmit one or more images to a further device (in the case of a facsimile machine). Next, the communication module 216 can receive confirmation from the other device that the other device can perform the requested function, as indicated in block 508.

Once confirmation from the other device has been received, the communication module 216 can transmit the image data to the other device, as indicated in block 510. After this data transmission is completed, the communication module 216 receives a confirmation communication from the other device, as indicated in block 512, that indicates that the image data has been successfully received. At this point, flow is terminated, and further communications can be initiated, if desired, with the image capture device 102.

FIG. 6 illustrates operation of the communication modules 314 and 414 of the computing device 104 and the peripheral device 110. As indicated in this figure, a communication is first initiated, as identified in block 600. Again, this communication can be initiated first by the image capture device 102, or by the computing device 104 or peripheral device 110. Irrespective of the manner of its initiation, the communication is made in the universal language, ICL. Once the initial communication is made, the communication module 314, 414 receives a device identification communication from the image capture device 102 that indicates the nature of the image capture device, as indicated in block 602. Again, this communication can comprise a series of escape sequences that begin with a class identification. In a preferred arrangement, this communication is received and interpreted by the universal image capture driver of the communication module 314, 414.

After the device identification is received, the communication module 314, 414 transmits an acknowledgement communication to the image capture device 102, as indicated in block 604, that confirms that the device 104 or 110 is fluent in ICL and that it is compatible with the image capture device. At this point, the communication module 314, 414 receives a request for a particular functionality from the image capture device 102, as identified in block 606. In response to this request, the communication module 314, 414 communicates its capability of satisfying the request, as indicated in block 608. Where the device 104 or 110 is capable of satisfying the request, flow continues to block 610 in which the image data is received from the image capture device 102. At this point, the device 104 or 110 performs the requested operation, as indicated in block 612. As noted above, the operation performed will depend upon the nature of the device. For instance, where the device is a computing device, the operation may merely comprise storing the data. Where the device is a printer, this operation may comprise printing out hard-copies of one or more images. In one embodiment, ICL is used for all communications within the computing device 104 or peripheral device 110 such that the device is fluent in ICL throughout all levels of communication within the device. In another arrangement, the computing device 104 or peripheral device 110 is only fluent in ICL at a relatively high level and lower level communications are accomplished in another language in which the device is fluent. In the latter arrangement, the communication module 314, 414 can transmit an operation command to the control module 316 or 416 which issues all internal commands to the various applications and/or hardware responsible for performing the operation. In either case, communications with the image capture device 102 are unimpeded such that all required operations can be performed by the computing device 104 or peripheral device 110.

The advantages achievable through implementation of ICL in the manner described above are revealed in specific examples of use provided below.

### EXAMPLE 1

In the first example, a user owns a PC that is provided with a communication module such as module 314 illustrated in FIG. 3. This module includes a universal image capture driver that is fluent in ICL. The user then purchases a digital camera that speaks ICL. Once the user captures images with the camera, the user can transmit the collected image data to the PC. Notably, in that the universal image capture driver is stored on the PC, the user need not download an additional driver specific to the digital camera, thereby both simplifying use of the camera and saving storage space on the PC's hard drive.

Later, if the user should purchase another image capture device (e.g., a scanner), interaction between the other device and the PC is facilitated by the universal image capture driver and, again, no specific driver or other software is necessary for communications between the PC and the other device. Accordingly, the user can utilize a single driver for substantially all image capture devices without the need to provide separate drivers for them. Moreover, in that only one driver is needed, the user need not replace multiple drivers for the various image capture devices he or she owns as driver updates are released. Instead, the user can simply replace or update a single universal image capture driver that operates in conjunction with many different image capture devices.

### EXAMPLE 2

A digital camera owner is on a business trip at a customer's premises. Before arriving at the customer's premises, the camera owner captured digital photographs that he or she would like to share with the customer. In that the camera owner may not be able to locate another person on the customer premises who has the same camera and therefore a specific driver for it downloaded to a PC, the camera owner would not be able to share the photographs with the customer. If, however, the digital camera speaks ICL and another device on the customer's premises (e.g., a PC or printer), is provided with a universal image capture driver fluent in ICL, the camera owner would be able to download the stored image data to the other device and the images could be shared.

### EXAMPLE 3

A vendor produces a hybrid device capable of both capturing images and printing hard-copies of the images once they are captured. Operating in this manner, the hybrid device is similar to analog “instant” developing cameras. To enable the hybrid functionality, the device comprises hardware for capturing images as well as hardware for printing them out in hard-copy form. After a year of production, the vendor becomes aware of a new print engine made by a third party company that has a higher resolution from a print engine currently used in the hybrid device. Where the new print engine speaks a different language than that spoken by the internal components of the hybrid device, several months of firmware development could be necessary to integrate the new print engine into the device. If, however, both the new print engine and the hybrid device components speak ICL, integration would primarily comprise mere physical integration of the print engine into the hybrid device.

The aforementioned examples provide an indication of only but a few of the many different situations in which advantageous results can be achieved through the implementation and use of ICL. Persons having ordinary skill in the art therefore will appreciate that similar advantages exist in other situations. For instance, where a device does not speak ICL, it will be appreciated that communications with the device can be facilitated by transmitting a universal image capture, to the device for download. In this manner, the device can be “taught” ICL.

What is claimed is:

1. A method for communicating image data to an electrical device, comprising the steps of:
transceiving a device identification to the electrical device in a universal image capture language; and
transmitting image data to the electrical device.

2. The method of claim 1, further comprising the step of receiving an acknowledgement communication from the electrical device in the universal image capture language.

3. The method of claim 1, wherein the device identification comprises at least one escape sequence.

4. The method of claim 1, wherein the device identification is transmitted from an image capture device.

5. The method of claim 1, wherein the electrical device comprises a computing device.

6. The method of claim 1, wherein the electrical device comprises a peripheral device.

7. A method for receiving image data from an image capture device, comprising the steps of:
receiving a device identification from the image capture device communicated in a universal image capture language;
interpreting the device identification; and
receiving the image data from the image capture device.

8. The method of claim 7, further comprising the step of transmitting an acknowledgement communication to the image capture device in the universal image capture language.

9. The method of claim 7, wherein the device identification comprises at least one escape sequence.

10. The method of claim 7, wherein the device identification is received by a universal image capture driver.

11. The method of claim 10, wherein the universal image capture driver comprises part of a computing device.

12. The method of claim 10, wherein the universal image capture driver comprises part of a peripheral device.

13. An image capture device, comprising:
a processing device adapted to control operation of the image capture device;
an image capture module;
a communication module that communicates in a universal image capture language;
image capture hardware adapted to retrieve and store image data; and
a device interface adapted to facilitate communication with other devices.

14. The device of claim 13, wherein the device comprises a digital camera.

15. The device of claim 13, wherein the device comprises a scanner.

16. An electrical device, comprising:
a processing device adapted to control operation of the image capture device;
a communication module that communicates in a universal image capture language
a control module; and
a device interface adapted to facilitate communication with other devices.

17. The device of claim 16, wherein the communication module comprises a universal image capture driver that is adapted to communicate with a variety of different image capture devices.

18. The device of claim 17, wherein the universal image capture driver is adapted to communicate with a digital camera and a scanner.

19. The device of claim 16, wherein the memory includes a control module comprising at least one software application with which image data can be manipulated.

20. The device of claim 19, wherein the device comprises a computing device.

21. The device of claim 16, further comprising device operation hardware adapted to perform a particular physical operation and wherein the memory comprises an operation module that is adapted to control operation of the operation hardware.

22. The device of claim 21, wherein the device comprises a peripheral device.
